(19) United States
(12) Patent Application Publication
(10) Pub. No.: US 2020/0334752 A1
(43) Pub. Date: Oct. 22, 2020

(54) SYSTEMS, METHODS, AND STORAGE MEDIA FOR CONFIGURING A DATA STORAGE AND RETRIEVAL SYSTEM FOR MANAGING DATA RELATING TO TOKENIZED ASSETS

(71) Applicant: SECURRENCY, INC., Arlington, MD (US)

(72) Inventors: George Daniel Doney, Riva, MD (US); Ihor Yermakov, Odessa (UA)

(73) Assignee: SECURRENCY, INC., Arlington, MD (US)

(21) Appl. No.: 16/851,184

(22) Filed: Apr. 17, 2020

Related U.S. Application Data
(60) Provisional application No. 62/834,999, filed on Apr. 17, 2019.

(51) Int. Cl. G06Q 40/04; G06Q 20/36; H04L 9/32

(52) U.S. Cl. CPC G06Q 40/04; G06Q 20/3672; G06Q 20/3678; H04L 2209/56; H04L 9/3213; G06Q 2220/18; G06Q 20/3676

(57) ABSTRACT

An apparatus, computer-readable medium, and computer-implemented method for configuring computing systems to facilitate decentralized asset management for individual assets and composite assets such as funds. Implementations include smart contract interfaces to link fungible tokens to non-fungible asset tokens to decouple securities transaction logic and corporate functions from asset management to facilitate code reuse. Additionally, the embodied process uses token nesting to enable homogeneous or heterogeneous assets to be combined into a fund structure, and further for funds to be composed into fund of fund models. The flexible structure enables automation of fund management and is designed to facilitate broad investor access to innovative asset management strategies that leverage the disclosed structure.

### RELATED APPLICATION DATA

This application claims benefit to non-provisional application of U.S. provisional application Ser. No. 62/834,999 filed on Apr. 17, 2019, the disclosure of which is incorporated herein by reference.

### FIELD OF THE DISCLOSURE

The present disclosure relates to systems, methods, and storage media for configuring a system for managing data relating to tokenized assets.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

In finance, a derivative is an asset that derives its value from the performance of an underlying entity. This underlying entity can be an asset, index, or income stream, and is often simply called the “underlying”. Derivatives can be used to provide access to otherwise hard-to-trade assets or markets. One type of derivatives is a Residential Mortgage Backed Security (RMBS) which are often aggregated into funds or Exchange Traded Products (ETP). An RMBS fund is an investment similar to a bond that is made up of a bundle of home loans purchased from the banks that issued them. Investors in RMBS funds receive periodic payments similar to bond coupon payments. Also, other derivatives, such as futures and forward contracts, swaps, and options are often aggregated into funds.

Most economists agree that the root cause of the 2008 Global Financial Crisis (GFC) was the eroded performance of RMBS funds. While asset underperformance in markets is common, the lack of effective pricing and transparency in the performance of the RMBS fund assets over time resulted in a toxic spread of risk across the financial system due, in part, to inadequacies of computing platforms supporting the financial systems. When the extent of the risk was eventually understood by the markets, it resulted in a ripple effect as market liquidity evaporated in the face of balance sheet uncertainty. Markets froze, stalwart institutions fell, and, without the aggressive intervention of global governments at a substantial cost to taxpayers, it is likely that the entire financial ecosystem may have collapsed resulting in a global depression.

The lack of pricing and transparency in derivative funds, and other funds, is largely an information technology problem. The complexity tracking underlying assets often represented in widely varying systems operated by parties with different levels of sophistication, the aggregation of these assets into funds, and the fractionalization of funds into shares, when combined with the dynamics of market conditions, makes it difficult, if not impossible for conventional computing platforms to adequately communicate valuation to market participants, and other stakeholders, in real time. For example, in the simple case of an RMBS fund of thousands of mortgage backed securities, valuation is dependent on current interest rates, the creditworthiness of each homeowner/mortgagee, the payment status of each mortgage, housing valuations in each region and many other dynamic conditions that can be specific to each of the thousands of mortgages. Currently, there is no way to gather all of this information and process the same for valuation in a real-time manner. These limitations are the primary contributor to the lack of effective pricing and transparency that contributed to the GFC and which continue to contribute to market uncertainties.

It has been proposed that Distributed Ledger Technologies (DLT), such as blockchain, could be applied to various financial transactions to increase transparency because one of the principal benefits of DLT is the ability to obtain a transparent, immutable and auditable record of transactions and data. A flood of DLT projects have emerged demonstrating the utility of “tokenizing” (i.e. creating a unique digital ID for) any asset that has value, including equity and debt instruments, artwork, virtual collectables, documents, energy, and much more. However, current data models and architectures do not provide a common model for the communication of valuation and other diligence data, mechanisms for combination and management of complex and dissimilar assets, such as derivatives and derivative funds, in a flexible manner.

### SUMMARY

The applicant has created a data model and computer architecture that streamlines and decentralizes asset management while providing improved data processing, of valuation for example. Implementations include methods executed by at least one computing device on a distributed ledger over a computer network using a smart contract to issue cryptographic tokens representing assets. Implementations include a novel data structure and interface designed to enable token nesting, that is, tokens as assets that contain other tokens as assets. Since investment funds are assets that contain assets, this novel data model provides a processing backbone on which advanced fund strategies, valuations and asset management may be performed in a decentralized manner. However, the implementations include centralized architectures and also provide data processing and communication advantages with respect to these architectures. Additionally, the novel token data structure and interface design enable shared transaction logic, comprehensive auditability and scalable record keeping, while decoupling individual asset behavior and associated logic. The structure permits reuse of basic transaction logic and asset management functions. Disclosed implementations support a wide variety of asset types, permit the formation of simple fund structures with homogeneous assets (or complex diversified funds with heterogeneous assets) and can expose “plug-in points” that facilitate rapid innovation in novel fund management approaches.

Disclosed fund structures can create a repeatable model to enhance investor transparency, reduce the cost of fund maintenance, and streamline the path to market for new asset classes and fund management strategies. Using disclosed implementations, a party offering an asset management strategy, known as an Issuer, can deploy a market ready asset on a decentralized networked computing platform in minutes including, if desired, complex and highly regulated instruments like Exchange Traded Funds (ETFs).

Disclosed implementations define a computer architecture, computer readable data structure, and computer interface implementation to inspect, value, transact, combine, and manage any asset type including composite assets, e.g. funds. When coupled with the token framework disclosed in US Published Patent Application No. US20190164151 A1, the model provides a fully functional decentralized architecture for global regulatory compliance, scalable transaction logic, simplified management, and transparent asset performance. The result is an automated, standards-based, self-reporting fund that can be leveraged by any Issuer to automatically execute the desired asset management strategy on behalf of investors on a decentralized platform.

Disclosed implementations provide framework that includes a non-fungible token representing a fund shell, that is, a fund structure that handles general purpose fund management functions such as adding and removing assets or publishing valuation, may be populated with assets, and can incorporate third party smart contracts, if desired, for waterfall processing of fund proceeds. The shell provides a plugin structure so that fund management strategies can be handled manually, through stakeholder voting, or via automated asset management strategies. Automated strategies, colloquially known as “robo-advisors”, are gaining traction as efficient models for asset allocation. The disclosed implementations permit rapid innovation in the development and deployment of automated (or manual) management strategies on a decentralized network by decoupling asset allocation logic from general purpose fund processing.

The applicant discloses a novel fund management strategy called “elastic securitization”. This strategy permits a closed end fund, that is, one in which there are a fixed number of shares, to expand or contract in size (assets under management) based on market demand without the use of authorized participants. This innovative approach is helpful to support exchange traded funds of illiquid assets and thereby provides investors access to new classes of assets via the ETF harness.

Disclosed implementations include interface specifications to link tokenized assets to a fungible token transaction framework extending conventional DLT practices for value transfer (Ethereum ERC20 standard as an example) with logic for corporate governance, payment distributions, and policy enforcement (as disclosed in US Published Patent Application No. US20190164151 A1). The resulting data structure allow a decentralized architecture to automatically communicate value of tokens, funds and other complex assets. This provides investors, that is, holders of a fungible digital token, the ability to efficiently inspect the value that they own, even for complex fund structures with heterogeneous and nested assets (e.g., a fund of funds). An investor, or other stakeholder, may review both overall performance and an enumerated list of the underlying assets with consistent and real-time access to the performance, cash flows, and data for each asset. The disclosed implementations permit: greater transparency into the performance of underlying assets; greater regulatory oversight of fund operations; and lower cost of operations for asset managers. Had RMBS funds been implemented with the disclosed computing architecture prior to 2008, many factors believed to contribute to the Global Financial Crisis (GFC) would have been alleviated.

One aspect of the present disclosure includes a method for configuring a data storage and retrieval system for managing data relating to tokenized assets, the method comprising: creating a digital token in accordance with a class definition, the token including a unique token identifier; registering the digital token in association with an asset as a unique record in a memory device of an asset registry; associating a communication interface with the digital token in accordance with the class definition, wherein the communication interface is compliant with a communication specification implemented by the asset registry and which is configured to expose a set of predefined functions, wherein the predefined functions include asset ownership transfer functions, asset valuation publication functions, asset attribute determination functions and asset specific processing logic.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is a schematic diagram of a computing architecture for creating, configuring, and managing tokenized assets in accordance with disclosed implementations.

FIG. 2 is a schematic illustration of the basic non-fungible asset token and its high level interfaces in accordance with disclosed implementations.

FIG. 3 illustrates the process flow of asset token sales and purchases in accordance with disclosed implementations.

FIG. 4 illustrates the interface specifications for asset valuation functions in accordance with disclosed implementations.

FIG. 5 illustrates the flow of a valuation process in accordance with disclosed implementations.

FIG. 6 is a schematic illustration of the basic fund token and its high level interfaces in accordance with disclosed implementations.

FIG. 7 is a schematic diagram illustrating examples of token wallets owning other tokens in accordance with disclosed implementations.

FIG. 8 is a schematic illustration of a connection of a non-fungible asset to a fungible asset token to support fractional ownership is a schematic illustration of the basic non-fungible asset token in accordance with disclosed implementations.

FIG. 9 illustrates basic fund operations than can be automated using a decoupled asset management logic and a fund structure in accordance with disclosed implementations.

FIG. 10 is a flow chart of a method for configuring a computing platform to process a fund structure in accordance with disclosed implementations.

### DETAILED DESCRIPTION

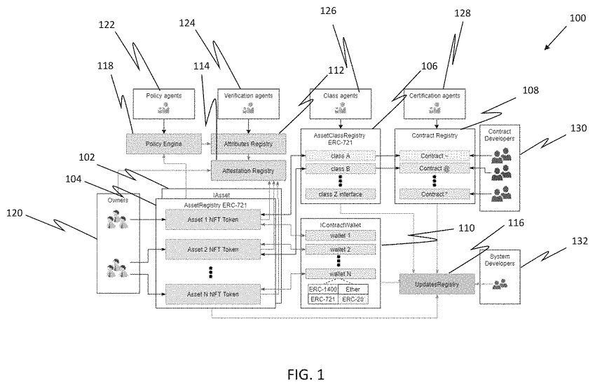

FIG. 1. illustrates computer architecture 100 for tokenizing and managing assets in accordance with disclosed implementations. In some implementations, architecture 100 may include one or more computing platforms that may be configured to communicate with one or more remote computing platforms according to a client/server architecture, peer-to-peer architecture and/or other architectures. The platforms may be configured by machine-readable instructions which may include one or more instruction modules. The instruction modules may include computer program modules stored in non-transient memory.

An investment fund, such as an ETF, is used herein as an example of an asset that can be managed with the disclosed implementations. To create and launch an ETF fund in accordance with disclosed implementations, issuers follow a multistep process including: ( 1) tokenizing fund assets using predefined specification (referred to as an “IAssetToken” specification herein) of IAsset module 102 (described in detail below); (2) tokenizing the fund itself using with a predefined specification (referred to as an “IAssetFund” specification herein) of IAsset module 102 (described in detail below); (3) using a novel token data structure enabling asset management, enumeration, and nesting, attach tokenized assets to the fund using an AddAssetRequest function (described in detail below); and (4), if desired, attach a non-fungible token to a fungible token using an IAssetManagementFungible interface (described in detail below) of IAsset module 102 (described in detail below) to support fractional ownership and simplified transactions. Note that the tokens of the disclosed implementations are sometimes referred to as “IAsset tokens” herein. All of these specifications, interfaces, process steps and data structures facilitate fund management in decentralized systems and are described in detail herein. Examples of source code implementing the various functions and interfaces is included in the Appendix which is a part of the specification of this patent application.

Asset registry module 104 includes a smart contract, AssetRegistry, that issues and tracks tokens representing assets. These tokens implement interfaces to manage relationships between assets and expose basic asset functions, such as valuation functions. Assets may be assigned a class that can be tracked in AssetClassRegistry module 106. The term “class”, as used herein, is well known in the field of object oriented programming and can refer to a “blueprint” for creating objects (a particular data structure), providing initial values for state (member variables or attributes), and implementations of behavior (member functions or methods).

An asset class assignment enables the token to expose properties and functions specific to that class. ContractRegistry module 108 enables developers to publish new interfaces and implementations to enhance or extend, e.g. upgrade) the behavior of all assets in a class. IContractWallet module 110 implements and manages smart contract-based cryptographic wallets that can be attached to individual token representing assets, classes, or other elements providing wallet functionality via that asset. AttributesRegistry module 112, AttestationRegistry module 114, UpdatesRegistry module 116, and PolicyEngine module 118 are used by assets (and other services) in the manner described below.

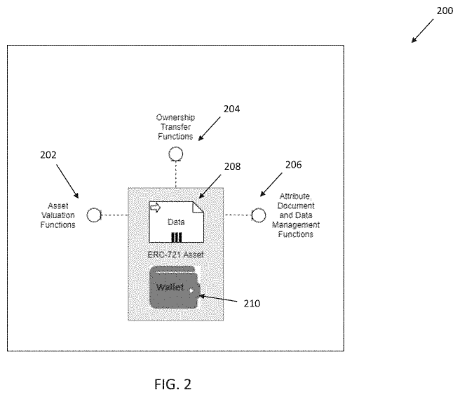

On issuance of a token, an AssetRegistry smart contract of AssetRegistry module 104 assigns an asset class to the token and deploys a new smart contract implementing the IContractWallet interface to thereby associate a wallet with the token. As a result, each created token will have a unique wallet address (as shown in FIG. 2) linked to the token by its identifier and may implement properties and functions of an assigned asset class. AssetRegistry module 104 operates the IWalletContract interface and enforces policy for actions regarding the wallet. Typically, the policy will only allow the owner of the token to execute actions via the wallet contract. The wallet will support functionality for transfer or receipt of tokens and, optionally, cryptocurrency such as Ether (ETH). Wallets can support tokens compatible with ERC-20, ERC-721, ERC-1400, and other standard interface tokens.

The smart contracts, implemented by IContractWallet module 110 operates wallets and will support upgradability via UpdatesRegistry module 116 (like all other system components). This structure allows registration of new wallet smart contracts implementing changed or upgraded behavior. The token owner, or other designee, may choose to assign a new wallet contract to the token to implement the upgraded functions or may reject such an assignment in some cases. ContractRegistry module 108 stores smart contract interfaces that provide customized functions for an AssetClass (from AssetClass registry module 106) or Asset instance (from AssetRegistry module 104). Each token may be assigned a class which provides access to the attributes, functions and implementation logic of the class. The Asset or AssetClass owner (or designee) can select an implementation from the interface registry. Developers can submit new Smart Contracts with custom implementations to ContractRegistry module 108 for owners to select in order to expose the custom logic for their asset.

A smart contract can be deployed on a distributed ledger that implements AssetRegistry module104 to enable issuance of non-fungible tokens representing individual assets. The physical deployment of the smart contract implementing AssetRegistry module 104 is not described in detail herein as such deployment can use conventional techniques that are well understood by those of ordinary skill in the art.

Token Owner modules 120 are associated with systems of parties who exercise control over assets (represented by, for example, non-fungible tokens) in Asset Registry 104. This control may be exercised via wallets directly or indirectly through rights allocated via fungible or non-fungible tokens that have control authority over the asset.

Policy Agent modules 122 are associated with systems of parties with the authority to publish policy that govern token behavior. The Token Owner may designate a published policy to govern specific actions performed on or through the token. Details on Policy Enforcement are disclosed in the Compliance Aware Token disclosure.

Verification Agent modules 124 are associated with systems of parties that create attributes, that is characteristics or properties of objects in the system. Verification Agents have the ability to attest to attribute values associated with objects. For example, a legal firm may serve as the Verification Agent that a fund asset is a 1940 Act fund for the purposes of regulatory policy enforcement.

Class Agent modules 126 are associated with systems of parties who exercise control over Asset Class tokens. Using this control, the Class Agents may select attributes and interfaces that apply to all asset tokens that are associated with the class.

Certification Agent modules 128 are associated with systems of parties who certify that smart contract code published by Contract Developers performs the function as described, are secure, and are free from defect.

Contract Developer modules 130 are associated with systems of parties that develop smart contract code to be used by asset tokens to perform functions associated with the asset class. These functions may be added, upgraded, or removed by a Class Agent once certified by a Certification Agent.

System Developer modules 132 are associated with systems of parties authorized to publish updates to core elements of the system such as the Asset Registry modue1104 or Contract Wallet module110.

It should be appreciated that the modules illustrated in FIG. 1 can be implemented within a single processing unit or multiple processing units, one or more of the modules may be implemented remotely from the other modules. The description of the functionality provided by the different modules is for illustrative purposes, and is not intended to be limiting, as any of modules may provide more or less functionality than is described. For example, one or more of modules may be eliminated, and some or all of its functionality may be provided by other ones of modules.

FIG. 2 is a schematic representation of a token data record (the token and related data structures) 200 in accordance with disclosed implementations. Asset Registry 104 can implement, for example, the Ethereum Request for Comment (ERC 721) standard interface (or equivalent on other distributed ledgers) to enable the issuance of non-fungible tokens. (See, e.g. , https://github.com/ethereum/EIPs/blob/master/EIPS/eip-721.md). Additionally, Asset Registry 104 implements the novel interfaces described herein that facilitate functions for asset management in decentralized environments such as distributed ledgers. The functions can include asset valuation functions 202, ownership transfer functions 204 and data management functions 206. These interfaces and associated data structure(s), described in detail in below, permit the creation of composite tokens, that is, tokens that contain or are linked to other tokens, in a structure that can be recursive. This novel structure is described in greater detail below and permits implementation of a fund, a composite asset that contains other assets, over a decentralized computer architecture.

Consistent with the ERC-721 token specification, Asset Registry module 104 facilitates the issuance of non-fungible tokens, with each token representing a unique asset. For each issued token, Asset Registry module 104 records data 208 such as: the unique identifier for the asset token; the asset class from Asset Class Registry module 106; the asset name and description; the address of the token's wallet 210 (described below); and other data as desired for the asset. The token data record 200 stored by Asset Registry module 104 defines the non-fungible token. The token may be assigned additional attributes and values using the methods disclosed in in US Published Patent Application No. US20190164151 A1. The digital tokens can implement the IAsset interface of IAsset interface module 102, exposing a set of functions, such as functions 202, 204, and 206, that facilitate asset management over a decentralized computing platform in the manner described below. Using data structure 200, any asset of value may be “tokenized”, that is, issued as a unique record on a distributed ledger reflecting the asset's ownership and coupled with supporting essential asset management functions needed to support scalable operations, such as fund operations. As described in detail below, IAsset interface module 102, supports specific functions that enable an asset to: present consistent data and valuation information; participate in funds and other asset management structures; implement asset specific logic; and/or encapsulate other tokens representing value instruments that are not created with native asset management capabilities.

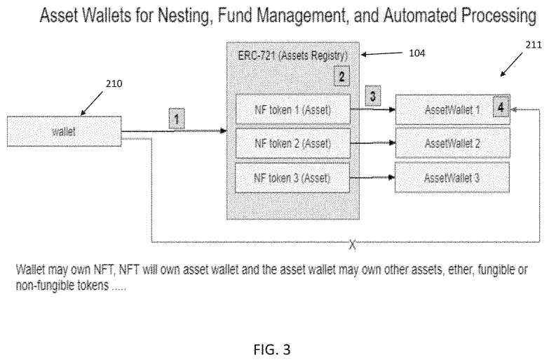

As noted above and shown in FIGS. 2 and 3, a token 200 is associated with a cryptographic wallet 210. Disclosed implementations include an interface specification and data structure enabling a smart contract and/or a discrete token to be associated with, i.e. to own, a cryptographic wallet. This novel structure makes it possible for a token to own other tokens and add or remove other tokens from its ownership and to conduct transactions with other entities by interacting with wallets 211 corresponding to other tokens or entities. A token that owns a corresponding wallet containing other tokens, thereby representing a token-in-token structure, is referred to as a “composite token” herein.

Non-fungible tokens in the Asset Registry are assigned a wallet 210 (FIG. 2) on issuance by the asset registry 104 by implementing the IAssetRegistry.IssueAsset function using an IAssetWalletFactory interface (see Appendix for code example). This interface issues a smart contract implementing an IContractWallet interface which is stored in Contract Registry 108 in association with the unique token ID. An example of code implementing this interface can be found in the Appendix.

The wallet contract's interfaces can be executed using the IAssetWallet wrapper, that is, the set of functions conforming to the IAssetWallet interface specification published in the appendix that are available via the AssetRegistry smart contract for use by the owner of the IAsset token or other permission structures as implemented in the smart contract logic. If the signer is not authorized to execute the function as designated by Asset Registry 104, implemented as smart contract logic for example, the proposed operation (e.g., “send tokens”) will not be permitted and thus will not occur. The IAssetWallet exposes its wallet address via the GetWallet function of the attached code. This address can be used as an origin or destination for transactions in the same way as any wallet on the distributed ledger.

Linking a wallet to a token in this structure enables useful effects such as: full traceability of the actions performed on behalf of the asset corresponding to the token, the ability to automate actions through an asset management smart contract that trades based on a strategy, the ability to conduct transactions with an asset's wallet as if transacting with an entity, the ability to insert robust policies (such as those disclosed in US Published Patent Application No. US20190164151 A1) into asset operations including operations via the asset wallet.

As shown in FIG. 3, the “token-in-token” structure, in which wallets corresponding to tokens can own other tokens, enables the creation of tokenized composite assets. One type of composite asset is a fund, a financial asset that contains other assets. When issued as an IAsset token supporting the IAssetManagement interfaces, the token supports asset management transactions enabling the execution of a fund management strategy manually by a fund manager or automatically via a smart contract based algorithm on a distributed ledger. Using this model, composite assets can be tokenized and can contain, add, or remove assets like cryptocurrencies, other asset tokens (simple or composite), or tokenized shares of assets.

Further, the token-in-token structure can be used to “wrap” third party tokens that do not support asset management with the IAsset token interface, to be managed in fund structures as individual assets. Wrapping a third party token can be accomplished through a simple transfer to the IAsset token's wallet. This will allow any token or smart contract to be wrapped and processed as an asset exposing a consistent structure for automated asset management and fund operation. With these technical elements in place, it is possible to quickly launch complex self-processing funds. For example, in and ETF structure, one or more non-fungible tokens representing individual assets can be issued via the Asset Registry module 104 using the IAssetRegistry.IssueAsset function (see example code in Appendix). Each token implements the IAsset interface which extends the basic ERC 721 specification with ownership transfer functions implemented via the IAssetTransferable interfaces to support asset management, enhance transparency, and support purchase and sale of the asset in a marketplace.

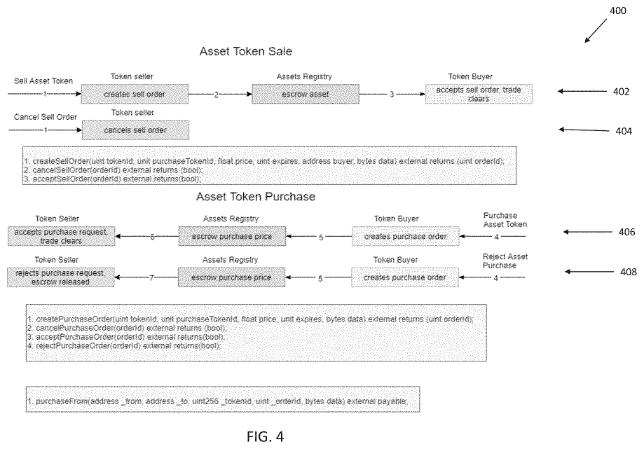

FIG. 4 schematically illustrates process flows 400 of asset ownerships transfer functions (shown as 204 in FIG. 2). As noted above, tokens can implement the ERC 721 standard interfaces, which include conventional ownership and transfer functions defined in the ERC 721 specification. The tokens can also implement the compliance aware framework disclosed in US Published Patent Application No. US20190164151 A1. Implementations disclosed herein extend this framework with functions to enable systematic asset purchase, sale and linking.

As shown at 402 in FIG. 4, a sell order for a token can be created with the createSellOrder function that operates on a data structure including the parameters (uint tokenid. unit purchase Tokenid, float price, uint expires, address buyer, bytes data) external returns (uint orderId). A cancelSellOrder function operates on the order id and returns a Boolean. Assuming that the the cancelSellOrder function returns FALSE, the token buyer accepts the sell order and an acceptSellOrder function is executed. As shown at 404, if the cancelSellOrder function returns TRUE, i.e. the sell order has been cancelled, the order process is terminated with a sale.

For a token purchase, as shown at 406, a createPurchaseOrder function is executed on a data structure including the parameters (uint tokenid, unit purcllaseTokenid, float price, unit expires, bytes data) and returns the order identification as an order ID in the form of (uint orderid). A cancelPurchaseOrder function is executed on the parameter (ordertd) and returns a Boolean. If the return is FALSE, the purchase can be accepted by execution the acceptPurchaseOrder function on the parameter (orderid) and the purchase is cleared. Alternatively, as shown at 408, the purchase is rejected by executing the rejectPurchaseOrder function on the parameter (orderid). As an alternative approach, the sell order may be executed by making a payment to the Asset Registry wallet including the orderID in the payload by executing the purchaseFrom function on a data structure including the parameters (address_irom, address_to, uint256_tokenId, uint_orderId, bytes data).

As noted above, transactions between tokens are accomplished by virtue of the wallets associated with the respective tokens. A token's wallet address may be obtained via the IAssetWallet.GetWallet interface which can be implemented by executing the code in the Appendix for example. Distribution logic may be initiated internally by the asset or externally using the interface.

An important aspect of transparency in financial markets is the ability of investors and prospective investors to view metadata, documents, and supporting data feeds for an asset. This information provides investors the means to develop their own sense for fair market price as well as providing a mechanism to assess the performance of intermediaries, like the asset manager, tasked with the responsibility to assess price in the market. Conventionally, such information has to be collated in a static manner and thus time-based reporting of the data is not pragmatic in prior art systems. Disclosed implementations include a comprehensive data structure for asset due diligence to provide scalable transparency; a function missing from the RMBS portfolios and other complex assets of the prior art.

Transparency requires the ability to create, maintain, and inspect asset properties or attributes. Since asset types vary widely, it follows that asset attributes vary even more broadly. To support data analysis across a broad range of assets, a consistent framework is required to manage any property of any asset as attested by any authorized party. An implementation includes the Attribute Management (ERC 1616) specification (https://eips.ethereum.org/EIPS/eip-1616) as a basic mechanism to manage asset properties. The disclosed implementations can also extend this specification via the Compliance Aware Token framework (see US Published Patent Application No. US20190164151 A1) to include scalable trust attestations and policy enforcement based on these attributes.

Additionally, asset due diligence often requires document and data management. distributed ledgers provide specific advantages for document management in that an immutable record can be provided for supporting documentation and data as well as an accessible framework to access this data. An implementation includes the Document Management (ERC 1643) specification (https://github.com/ethereum/EIPs/issues/1643). Disclosed implementations also include a mechanism to tokenize supporting datasets via a non-fungible token that describes the schema and other characteristics of supporting data using a non-fungible token. This specification supports advanced data authorization techniques, including the use of authorization tokens to provide distribution control and auditing of sensitive data. Policy-based data access and management can be achieved using techniques taught in the decentralized access control taught by US Published Patent Application No. US20190164151 A1.

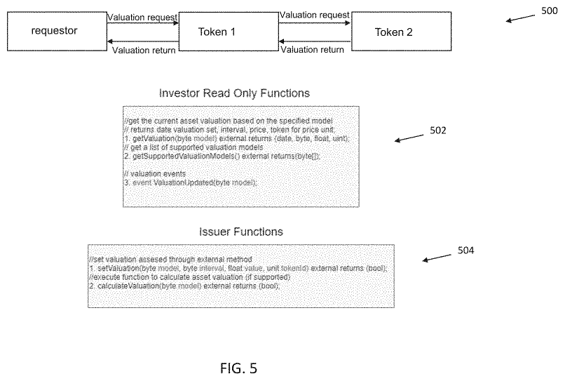

One the most important fiduciary responsibilities of an asset manager is to assess and publish the valuation of the managed asset. This provides investors a record of the asset manager's understanding of value based on the information available to the manager which, for most assets, exceeds the information that can be obtained by the investor at the time of the assessment. FIG. 5 illustrates an example of a process flow 500, and related data structures, for asset valuation functions of a disclosed implementation. These functions provide a consistent mechanism for publication and access to asset valuations. A common interface for valuation simplifies the integration of analysis tools. It also facilitates valuation of dissimilar assets facilitating the formation of diversified funds. As noted above, asset tokens expose valuation interfaces to enable investors to see current assessments of the asset's value. A range of known accounting techniques can be used to assess asset value. The technique used will be specified in the valueType attribute field for the asset. Asset tokens can have internal logic to support the value assessments. The Asset Valuation function can be implemented by executing the code example in the Appendix.

As shown in FIG. 5, a requestor (such as an investor), can make a getValuation request to a token 1 and a valuation of token 1 will be returned by token 1. The request can include the valuation model to be applied. If necessary, a getSupportedValuationModels request can be made to ascertain which valuation models are supported by token 1. The logic to generate asset valuation can vary across implementations and asset classes.

In one implementation, valuations can be published as attestations, that is attribute values assigned with full attribution by a validated party, by the asset owner, manager, or other authorized parties. In other implementations, the valuation data is generated by smart contract code in Asset Registry module 104 (FIG. 1) or as assigned to the class in Asset Class Registry module106 (FIG.1). This logic can use real time attributes of the asset to assess value, “oracles” to reach external sources of data such as exchange pricing, or other sources. For example, for an asset token representing a loan, the PAR valuation is the outstanding principal of the loan, an attribute (found in Attribute Registry module 112 of FIG. 1) of a loan token. As repayments are processed by the loan, the value assigned to this attribute is changed by the loan processing smart contract resulting in a different value for the attribute. Details regarding Attribute Registry module 112 implementation and mechanisms to set and get associated value are disclosed in US Published Patent Application No. US20190164151 A1.

In one implementation, a request (GetValuation) for the valuation type “PAR” is configured via the AssetRegistry smart contract implementation to point to the “PAR” Value attribute in Attribute Registry module 112 (FIG. 1). This attribute contains the current principal, that is outstanding balance for the loan which is returned in response to the request. Some valuation results may require a complex real time analysis of data in order to generate a valuation. To illustrate a separate mechanism for obtaining a valuation, the loan's NAV calculation may be determined based on discounted cash flows and payment behavior of the loan recipient. Specifically, a valuation request for the valuation type “NAV” may utilize smart contract code assigned to the AttributeClass “Loan” via Contract Registry module 108 (FIG. 1), to calculate the Net Present Value of the loan based on current interest rates, the interest rate of the loan, and the payment history of the borrower based on cash flows that can be observed in the Asset Wallet.

As another example, the “MARKET” value may leverage an oracle, that is a commonly used method to obtain data from sources external to a distributed ledger. As disclosed separately, the Attribute Registry module 112 includes instructions to obtain the latest value, in this case the current exchange price for the asset. Although several examples are provided for clarity, implementations are not limited thereto. However, the means to assign a method to obtain this data that can be configured for each asset provides a novel mechanism to provide “self-reporting assets”, that is assets that contain within their data structure the means to calculate and publish their valuation. The method disclosed eliminates the dependency of an auditing or reporting system on specific implementations of the source of valuation data. This eliminates complex system integration required to generate valuations for complex assets, like funds, that contain many different sources of valuation data. Without the disclosed technique, investors often do not have the means to obtain this data. The resulting lack of transparency can have devastating effects as was demonstrated in the 2008 Global Financial Crisis.

The data structures of the requests are shown at 502. Significantly, in the case of composite assets, token 1 may own child tokens and or may serve as a “wrapper” for another token in the manner described above. In such a case, token 1 will have to query all such tokens, token 2 in FIG. 5, in a similar manner for valuation prior to responding to the requestor. As shown at 504, when tokens are issued, a valuation can be set through token issuer functions.

While disclosed implementations expose a common interface for valuation, as noted above, different techniques can be used to calculate the valuation for the range of asset types that will be supported. Unique smart contract logic to calculate valuation for an asset type may be referenced via a known proxy technique, such as that disclosed at (https://hackernoon.com/how-to-make-smart-contracts-upgradable-2612e771d5a2). For example, many assets support a PAR value, that is, its face value. Most managed assets have a Net Asset Value (NAV) calculated based on the market price, liquidity, discounted cash flows, or other assessed value of its contents. If an asset trades regularly, it will have a market price and value. The PAR, NAV, and market values may be different for the same asset. For example, a loan has a PAR value based on the outstanding principal, a NAV based on the discounted cash flows and probability of default, and a market value if it is readily traded or has recently been purchased. Differences in these values can provide insight into changing market perception of asset performance, rating entities, or trust in the asset manager's value assessments.

Asset valuations may be assessed once, periodically, or in continuous near-real time. The data format provides the viewer (for example and owner or other market participant) information to know how stale a value assessment is, and for what interval it is expected to remain valid. Additionally, the specification can provide a link to a standardized feed of valuation history. This provides the reviewer a tool to look at the historical performance of the asset. A link is provided instead of direct access to the data since the storage, search, and indexing tools needed for historical analysis may be different than the tool (a distributed ledger in this implementation) where the asset token is stored.

While the disclosed implementations improve data communication and thus can close the gap between information available to the manager and the investor, flow of data can be controlled by the architecture, at policy engine 118 of FIG. 1 for example, to create a decision gap by design. For example, limitations of data flow relating to certain information may be desirable or in the interest of the investor. For example, the asset manager may want to withhold certain information from general availability to prevent “front running” (the practice of a broker or trader making trades just before a large non-publicized order to gain an economic advantage) or to otherwise protect investment performance or technique. The investor may choose to make a tradeoff between performance and transparency and the asset manager will be driven to disclose based on market demand balanced against the need for confidentiality.

As noted above with respect to FIG. 1, once assets have been tokenized using an IAssetToken interface of IAsset module 102 the next step in developing a fund, such as an ETF self-reporting fund, in accordance with disclosed implementations is the issuance of a fund token using the IAssetFund interface structure of IAsset module 102. This structure extends the IAssetToken structure and functions with the IAssetManagement interfaces. Fund tokens are issued via the IAssetRegistry interface of Asset Class registry module 106 (as with other tokens) but are assigned a type parameter equal to “Fund” by assigning the value for this class from the Asset class Registry module 106. Of course, a fund is an asset that may contain other assets. The same functions available for an individual asset apply to a fund. However, funds extend the basic logic of an IAsset token by providing the functions needed to manage the assets contained within the fund.

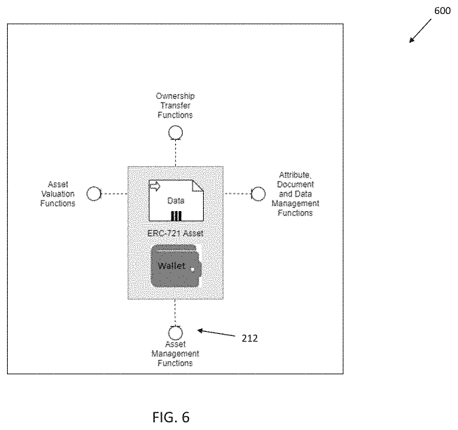

As shown in FIG. 6, a fund asset token 600 of disclosed implementations is similar to the asset token 200 of FIG.2. However, the fund asset management token includes asset management functions 212. Since asset management functions are implemented via the IAssetManagement interface of Asset Registry module 102, are assigned processing smart contract, and utilize the tokens wallet, all transactions can be recorded on a distributed ledger and are immutable. This provides transparency to simplify recordkeeping, auditing, and reporting. Asset management interfaces provide a consistent transaction infrastructure streamlining the development of logic specific to each asset class or fund management strategy. This facilitates the deployment of management strategies for new asset types executed via internal logic that can be replaced, extended, or upgraded without changing the core token structure and interface footprint. Further, this implementation supports a wide range of asset types via common asset management functions is a characteristic of this implementation.

More specifically, the fund token specification of fund token 600 extends the basic asset interfaces permitting authorized entities to enumerate all assets in the fund using the IFundManagement.GetAssets interface. Enumerating assets in the fund, each supporting the IAsset interface enables the viewer to drill into available information for contained assets. For example, the following fund management functions and related data structures can be supported.
addAssetRequest(uint tokened, uint purchaseTokenid, float price, uint expires, bytes data) external returns (uintorderid);
canceIAddAssetRequest(ordered) external returns (bool);
removeAssetRequest(uint tokened, uint purchaseTokenid, float price, uintexpires, address buyer, bytes date) external returns (uint ordered);
cancelRemoveAsstRequest(ordered) external returns (bool);
getAssets( ) external return (uint[ ]); //returns an array of addresses of attached non-fungible tokens
event AssetAdded(uint tokened);
event AssetRemoved(uint tokened)

An example of each function is included in the Appendix. Once a fund token has been issued, the next step in a fund creation process can be to transfer assets to the fund. Note that a fund can include zero to many assets. Assets are purchased or liquidated from the fund using the token's Asset Management Functions, AddAssetRequest & RemoveAssetRequest. As with any token transaction, the asset management actions are recorded on the distributed ledger. These functions are exposed as interfaces by the Asset Registry utilize the IAsset token wallet and the Asset Ownership Transfer functions to execute asset transactions in a manner similar to that described above with respect to token 200 of FIG. 2.

A non-fungible fund token 600 can be coupled with (i.e., “wrapped with”) a fungible token, such as token 200 using the IAssetManagementFungible interfaces to facilitate trading and other transactions. Any asset token can be wrapped with a fungible token implementing the IAssetManagementFungible interface to facilitate fractional ownership of the asset and reuse logic for corporate functions built for non-fungible tokens, such as dividend distributions to shareholders, shareholder voting, corporate communications and more. Tokens implementing IAssetManagementFungible structure include new smart contract interfaces (AddAssetRequest, Rem oveAssetRequest) that extend the ERC20 standard (Ethereum fungible token). These interfaces enable the fungible token issuer to add or remove one (and only one) asset token to/from the fungible token shell by transferring the non-fungible asset token using the defined functions in the IAssetManagementFungible interface.

The fungible token implementation also includes an interface (IAssetManagementFungible.GetAsset) to permit authorized parties to inspect the asset(s) that underlies the shares represented by the fungible token. The valuation functions exposed by the non-fungible token, which is coupled with the fungible token, permit the shareholder (owner of fungible tokens) to easily calculate their percentage ownership of the underlying assets. For example, if the NAV for an underlying asset is $1,000,000 and a wallet holds 100 of 1000 total shares (10%) in circulation of the that asset, then the total NAV of the fungible tokens in that wallet representing 100 shares is $100,000.

By separating the fungible token from the logic captured in the non-fungible token specific to the asset and its management, the implementation facilitates maximum reuse, and simplifies the development and verification, of asset specific code. Additionally, this approach preserves asset structure to facilitate merger or acquisition approaches where asset acquisition is desired instead of share acquisition for tax, governance, or liability reasons. Asset acquisition is a common technique in finance and, in the absence of the data model and architectures of the disclosed implementation, would not be a pragmatic task. The linked token approach facilitates the transfer of assets to and from exchange traded funds enabling asset liquidity when separate from a parent fund, but convenient management when purchased by a fund for securitization.

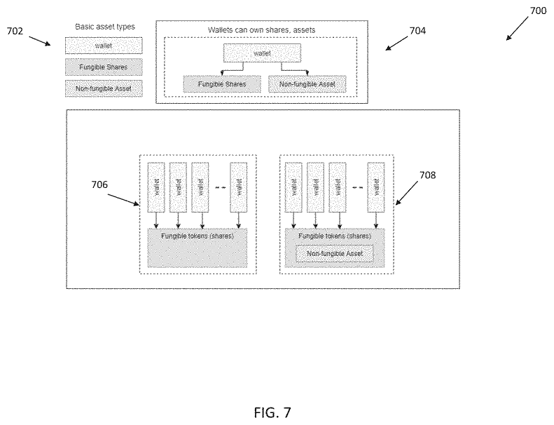

FIG. 7 is a schematic illustration of the data model 700 for wrapping a non-fungible asset token with a fungible token for transactions to enable, for example, fractional ownership of a fund represented by a fund token. “Fractional ownership” refers to the situation in which a fungible asset can be subdivided so there can be more than one owner of an asset. As shown at 702, the basic token types are “wallet”, “fungible share” and “non-fungible asset”. As shown at 704, wallets associated with tokens can own other tokens representing fungible shares and/or non-fungible assets through the mechanisms described above with respect to FIG. 1, for example. This simplifies the structure and smart contract code of the asset non-fungible token since it may utilize the dividend distribution and corporate governance function of the non-fungible token wrapper. Shares in a fund are represented by a fungible token and can be owned by one or more wallets or by assets as shown at 706. A smart contract linked to the fungible token exposes ownership and management functions for fungible assets in a fund, as shown at 708. The functions, which are also shown in the Appendix, can include:
addAssetRequest(uint tokenId, uint purchaseTokenId, float price, uint expires, bytes data) external returns (uint orderid);
canceIAddAssetRequest(orderId) external returns (bool);
rernoveAssetRequest(uint toKenId, uint purchaseTokenId, float price, uint expires, address buyer, bytes data) external returns (uint orderId);
cancelRernoveAssetRequest(orderId) external returns (bool);
getAsset( ) external return (uint); //Returns address of attached non-fungible token
event AssetAdded(unit tokenId);
event AssetRernoved(unrt toKenId);

For example, the asset may be a self-processing loan that pays the wallet that owns the asset as loan repayments are received. If this wallet is owned by the fungible token smart contract, these proceeds may be distributed proportionally to the owners of the fungible token. The parent-child token structure also facilitates reuse of established transaction logic and exchange functions in fungible tokens while permitting specialization in asset specific functions, in this case, loan processing. As noted above, a fund can have zero (null) assets as the fund is defined by the fungible token and the linked management smart contract.

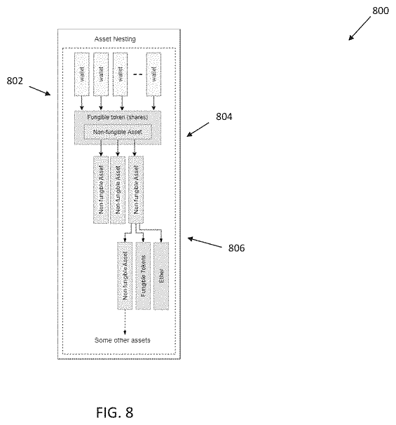

Since an IAssetFund token may contain any of the following: assets, asset tokens for other funds, fungible shares of other assets, or shares of fund assets, the implementation supports nesting of assets as shown in FIG. 8 which is a schematic representation of the data model for such nesting. Nesting facilitates a fund of funds structure and large-scale portfolio diversification techniques. As shown at 802, token wallets can own fungible tokens representing shares in a fund which in turn owns non-fungible assets as shown at 804. Further, as shown at 804, non-fungible tokens (representing a fund for example), fungible tokens, and other assets (such as the cryptocurrency ether in this example) can be owned by the non-fungible tokens. The wallet structure and architecture described above with respect to FIGS. 1, 2, and 6 permit this recursive ownership structure to be represented by a data model that can be used in connection with a decentralized system.

In the same way that IAssetFund extends the IAsset structure to implement Fund management functions, the IAsset structure may be extended for other asset types to permit token polymorphism. For example, an implementation may issue IAssetLoan tokens, that is, IAsset tokens with a class type Loan from Asset Class Registry module 106 of FIG.1. This class may implement self-processing loans, that is, loans that process payments internally via the IAsset wallet and assigned ProcessWaterfall smart contract logic. Custom smart contracts for payment processing can be assigned to loans by their owner using the AssignWaterfallProcess interface. This practice of enabling functions to be superceded by a derived class through inheritance is known as overloading. Overloading using the interface structure permits the execution of different loan processing strategies within the same fund.

By inheriting the IAsset structure, an IAssetLoan token can receive payment to its wallet in any accepted currency, process the payment including an update to any outstanding principal, process fees, and pass the proceeds to its owner. All transactions and payments can be inspected on the ledger providing transparency and data needed for asset valuation. Using the IAssetFund Asset Management Functions, the IAssetLoan token may be attached to a fund token. The loan token may be one of many IAssetLoan tokens to create a securitized fund. Loan payments are processed automatically by each loan with proceeds passed to the parent fund where they can be processed further as management fees, dividend distributions, and other fund functions as managed by the IAssetFund token. This structure creates a fully transparent, self-processing securitized loan pool that can scale indefinitely.

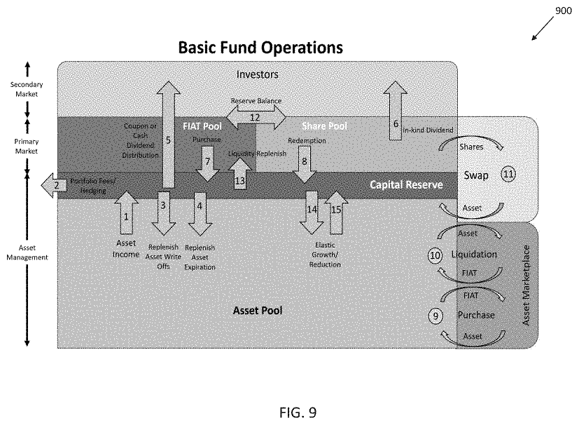

Self-processing, self-reporting loan assets in a self-processing, self-reporting fund provides transparency not present in the massive securitized loan (e.g., RMBS) funds that were at the root of the Global Financial Crisis. Similar techniques can be used to create funds of any type of asset providing investors access to a diverse set of new investment opportunities. Further, the data model and architecture described above simplifies the automation of more advanced fund management strategies. FIG. 9 schematically illustrates a fund management environment 900 with common transactions for asset management and in the primary and secondary market. The implementation supports each of the operations through the use of the IAsset and IAssetFund interfaces disclosed above. Each transaction of FIG. 9 is described below.

Process Asset Income to the Capital Reserve (1): Income earning assets in the Asset Pool (leases, bonds, debt instruments, dividend paying shares, etc) process income using internal automated or external models. These earnings are processed via the asset wallet for distribution providing full traceability of asset performance. When the fund token owner executes a ProcessWaterfall request via its IAsset interface, a ProcessWaterfall request is called for each of the IAssets owned by the fund. As a result of this request, the fund's assets transfer earnings to the Capital Reserve (IAsset wallet) of the fund. The fund executes internal waterfall logic to process these earnings. The waterfall logic may be a plugin smart contract to support innovative or repeatable fund management strategies. On completion of processing, funds are transferred to the token's owner as defined by the token's processing logic (which may result in the execution of further distribution logic by the token's owner).

Process Portfollio Hedging/Management Fees (2): Typically fund waterfalls will include payment of asset management fees and may also involve other internal services for fund operations such as hedging and insurance. These fees are paid out of the Capital Reserve (asset wallet) using wallet transfer logic and may be executed via the waterfall logic smart contract. To maintain a consistent par value of the fund, these payments must be replenished to from asset income or other sources.

Process Replenish Write Offs/Turnover (3): Assets may be written off (residual value deemed to be zero) in a given period. Write offs result from defaulted loans or underperforming assets. To maintain constant par value, write offs must be replenished using assets from the Capital Reserve as part of the processing waterfall. Sufficient balance should be held back (not distributed) in the Capital Reserve to support “at risk” income streams, i.e. overdue loans or underperforming assets that may default in upcoming periods.

Process Replenish Asset Expiration (4): For certain types of funds, such as those consisting of expiring, illiquid assets, asset residual values (earning potential) are reduced as income is processed from the asset. For example, a payment on a mortgage that reduces the principal of the loan result in a reduction in the earning potential of the asset, its residual value. To maintain a consistent earning potential of the fund, the residual should be replaced through the purchase of assets with similar or better earning potential. Realized earning potential results in a reduction of the residual value of the asset pool (expiration) while increasing cash in the funds Capital Reserve. Asset purchases using Capital Reserve assets uses the IAsset CreatePurchaseOrder function. Asset purchases to Realizing income from contained asset distributions to the fund typically increases the overall NAV of the portfolio (increase in Capital Reserve balance exceeds the reduction in NAV of the asset pool) proportional to the asset's income stream risk. Portfolios consisting of rapidly expiring assets (trade finance) will see significant expiration in a given period. The higher the expiration percentage, the greater the elasticity ratio of the fund (elasticity of the fund relative to the elasticity of underlying assets).

Process Coupon or Dividend Distributions (5): Funds may offer coupon income or cash dividends to owner/shareholders. “Cash” may be any asset (fiat, crypto, or other asset types) but is typically liquid, readily traded in a pair for shares of the fund, and in the same asset type as the asset income. Coupon Distributions are paid preferentially before other fund payments whereas Dividend Distributions are made from the proceeds that remain after other waterfall responsibilities are met. To ensure fund stability, Coupon Distributions should be less than the overall expected income from fund assets especially in the case of asset income volatility or uncertainty. Distributions are made via the ProcessWaterfall method. CAT fungible tokens contain shareholder distribution functions. By attaching the asset token to the fungible token, distributions to the funds shareholders may be processed automatically and at scale. Many funds do not offer Coupon Distributions or Dividend Payments. In these cases, asset income increases the par value of the fund.

Process In-kind Share Dividend (6): Rather than cash dividends, funds may pay distributions using shares of the fund. This strategy is used for some funds for tax purposes or to enhance liquidity. Funds from the Capital Reserve may be used to purchase the shares to be distributed. These shares may be purchased using several strategies: from a liquid secondary market, from a liquidity reserve pool (described later) in the primary market at the funds NAV, or by issuing share tokens consistent with the funds NAV. The flexibility of the share purchase, redemption, and distribution model enables the IAssetFund structure to support any existing fund management strategy including ETFs, mutual funds, or closed-end funds. This also supports fund revenue optimization strategies for tax or liquidity benefits.

Process Primary Market Purchase (7): The IAssetFund token may be attached to a fungible token to facilitate fractional ownership. Investors may purchase or sell fund shares in the primary market using the SharePurchaseRequest and SharePurchaseSwapRequest methods supported by the fungible token interface. For open-ended funds, that is, funds where the share count may change based on market demand for the underlying asset, shares are issued (purchase) or burned (redeem) to support the request. Based on the fund's operating model, shares are delivered to the purchasing party in exchange for assets or cash-in-lieu (CIL) of assets. SharePurchaseRequest is a CIL transaction. For this type of transaction, shares are sold at the fund's strike price, that is the fund's NAV divided by the total number of shares. The SharePurchaseRequest is made, the NAV is assigned, and the purchaser must fulfill the by supplying the “cash” assets required to fulfill the order. The IAssetFund token receives the cash and must purchase or assign the underlying from an asset marketplace or using the IAsset CreatePurchaseRequest function. SharePurchaseSwapRequest is used for transactions where the assets used for share purchase are consistent with the investment thesis or index (ratio of shares to underlying assets in the fund) of the fund.

Process Primary Market Redemption (8): This transaction is the opposite of the Primary Market Purchase transaction. Shares of the fungible token are sold to the fund in exchange for cash (ShareRedeemRequest), or assets from the underlying fund (ShareRedeemSwapRequest). Depending on the cash in the Capital Reserve, it may be necessary to liquidate assets from the IAssetFund token using CreateSellRequest.

One implementation includes the establishment of a liquidity reservoir as a part of the fungible token to enable elastic securitization. The liquidity reservoir is a smart contract that prices Primary Market transactions (or Secondary Market limit orders for a separate implementation) based on the net inflow or outflow of capital to the fund. The Reservoir maintains a pool of shares and cash that can fulfill the orders. Price is adjusted around NAV based on the deviation of the reserve pool balance from the desired balance as set by the fund manager. For example, a significant inflow of capital via an imbalance of SharePurchaseRequests will increase the cash pool in the reservoir while decreasing the available share pool. A pricing algorithm (smart contract plugin based on fund manager strategy) increases share price in the reserve pool increasing the likelihood of a redemption while decreasing the demand for new purchases. The algorithms react to adjust the price of liquidity in the face of changes in investor demand to return the reservoir to balance.

Process Asset Purchase (9): In some portfolios, portfolio managers purchase assets using cash from the Capital Reserve. These purchases use the IAsset CreatePurchaseRequest. For example, assets that expire can replaced with cash from the Capital Reserve replenished by asset income. NAV assessments and hedging strategies are the principal responsibility of a portfolio manager as these decisions reflect overall portfolio alpha.

Process Asset Liquidation (10): If the Reserve Balance falls below the Liquidation Threshold, actions are triggered requiring portfolio managers to sell assets to restore portfolio liquidity requirements. These triggers may be enacted via smart contracts and are executed through the IAsset CreateSellRequest.

Process Swap (11): In other portfolios, assets enter the portfolio via swaps, i.e. exchanges of income earning shares for rights to asset earning potential. Some portfolios may use both techniques to acquire assets. The use of a swap vice cash purchases are preferred as this introduces additional liquidity into the portfolio.

Process Replenish Reservoir (13): In an elastic securitization model applied to a fund of income producing assets, cash distributions can be used to restore liquidity in the Reservoir if reservoir cash levels are low based on a sustained exodus of shareholders. The amount of reservoir liquidity to be restored in this step is determined algorithmically, a function of Reservoir Balance, Capital Reserve, and market conditions. If significant liquidity restoration is required, resources may be unavailable to replenish expiring assets resulting in a reduction of the par value of the portfolio. If income levels fall below the liquidation threshold, this triggers the asset liquidation step as described below.

Process Elastic Portfolio Growth (14): A sustained price above the NAV resulting from a sustained imbalance of purchase orders creates a cash imbalance in the Reservoir. If this price exceeds the NAV by a threshold, the assets may be transferred to the Capital Reserve to purchase more assets into the fund driving the growth of the overall NAV of the fund. Using this model, the NAV of the fund can grow elastically without the use of Authorized Participants or the issuance of new shares.

Process Elastic Portfolio Reduction (15): Investor liquidity needs may result in a net outflow of value from the cash pool. A sustained imbalance resulting in pricing below NAV signals a need to liquidate assets from the fund to provide the cash needed to restore the cash pool. Sustained portfolio underperformance will result in controlled liquidation of assets under management gracefully drawing down a fund manager's influence based on the performance of assets under his or her control. While technically closed fund, the elastic fluctuation in par value based on investor demand and asset performance provides desirable characteristics of an open fund. \

Elastic securitization is a process that allows the graceful growth and reduction in the size of a fund containing illiquid assets. The process addresses a market need to provide fund structures to facilitate exchange trading of illiquid assets providing a liquidity buffer between liquid assets trading on an exchange and illiquid assets in the underlying fund addressing the concerns implicated by SEC Rule 22e-4.

The flexibility of the linked IAssetFund and IAsset structure provides a mechanism to execute common and advanced fund management strategies. The structure makes it possible to automate common asset management functions and inject innovative fund management strategies while providing a transparency and simplified auditing and reporting. Linking fungible tokens to the non-fungible IAssetFund token provides new utility for fund shares. Shares may be: held for income (dividends) or growth; transferred as payment; held in escrow as collateral; monetized through exchange in authorized secondary markets for USD, BTC, EUR, or other securities; and/or used to participate in fund governance through proxy voting.

The disclosed implementations enable fund assets to be purchased or redeemed from the asset pool using fund shares via a swap mechanism. This creates a “backing” model enabling assets to be added or removed from the fund using token issuance and destruction. Additionally, an implementation may contain a liquidity pool to manage the net inflow and outflow of capital into the fund. A liquidity algorithm can be applied to set share price to help manage redemptions and facilitate the formation of a secondary market for the fund's shares. This model is repeatable and can be used to meet nearly any fund structure: Lending, Debt Instruments, Receivables, Structured Settlements, Factoring, Trade Finance, Insurance, Leases, etc.

As one example of a fund structure that automated by the disclosed implementations, a closed-end Lending Pool fund can be created leveraging a fund smart contract. The pool is funded from existing assets, warehoused loans, rehypothecation, or capital formation. At first, the pool contains only the capital (fiat or crypto) needed for lending. Using the fund smart contract format, the Pool exposes a NAV and PAR value (sum of the NAV and PAR value of all assets in the pool) and publishes supporting documents and a list of assets in real time. All fund transactions are recorded on an immutable ledger. The pool has a Portfolio Manager, Asset Manager(s), and optionally other services (hedging, asset insurance, etc.) Loans are originated by authorized agents and funds disbursed through an automated process. On origination, loans are added as assets to the fund. Using the disclosed implementations, all assets (available lending capital, receivables, and other assets) can be viewed by authorized parties in real time.

Loans are originated from the pool as smart contracts extending the (Asset Smart contract. This facilitates securitization, fund operations, and compliant transfers. As ‘Asset objects, they publish supporting documentation, transaction history, and real time asset NAV & PAR value to authorized viewers. Loan Tokens leverage the IAsset structure to publish loan characteristics to enable independent analysis and valuation. Loan tokens may be wrapped in ERC-20, ERC-721, or other tokens to govern transfers.

Incorporated in the loan token is valuation and payment processing logic. Payments are made via simple transfers to an address (e.g. example specified in a QR code) specific to the loan. Payments are processed and proceeds are transferred to the asset's owner which may be a fund. The PAR value (Loan principal) and NAV (risk adjusted NPV of cash flows) for each loan are updated in real time with each payment. Transaction history for each loan is recorded on an immutable ledger and available for analysis by authorized users.

Pool Payment processing is automated and transparent. Proceeds from repayment of individual loan assets in the fund are transferred to the Risk Pool for further processing Risk Pool processing logic leverages a customizable smart contract to automate redemptions, loan write-offs, Pool capital replenishment, management fees, and dividend & coupon payments via a transparent and verifiable waterfall. Dividend and coupon payments and other distributions are transferred automatically to fund owners using fund logic embodied in a smart contract.

For enhanced liquidity and risk management, assets may be sold from (or purchased into) the portfolio. Supported asset transactions include purchase/sale via loan markets, redemptions and swaps using fund tokens. Other transactions include collections and write-offs. Dividend payments can be made in cryptocurrency, fiat, or in-kind pool tokens. Token issuance may occur through a primary market offering, auction, or through a tokenization of existing interests. Shareholders (Token holders) receive coupon & dividend distributions automatically and proportional to share ownership. The result is dividend paying tokens. Asset backed security tokens are revolutionary financial instruments. The tokens can be: (1) held to receive a dividend; (2) transferred as payment; (3) held in escrow as collateral; and/or (4) monetized through exchange in authorized secondary markets for fiat currency, cryptocurrency, or other securities.

Using elastic securitization mechanisms, growth in demand for tokens results in an influx of capital (in a model similar to growth in demand for a mutual fund). Additional capital results in expansion of lending pool PAR value providing more assets for lending. This model can grow indefinitely Similarly, capital exodus caused by underperformance or other factors results in a controlled drawdown of portfolio NAV. This model is repeatable and can be used to meet nearly any securitization need, including lending, debt instruments, receivables, structured settlements, factoring, trade finance, insurance, leases, and the like.

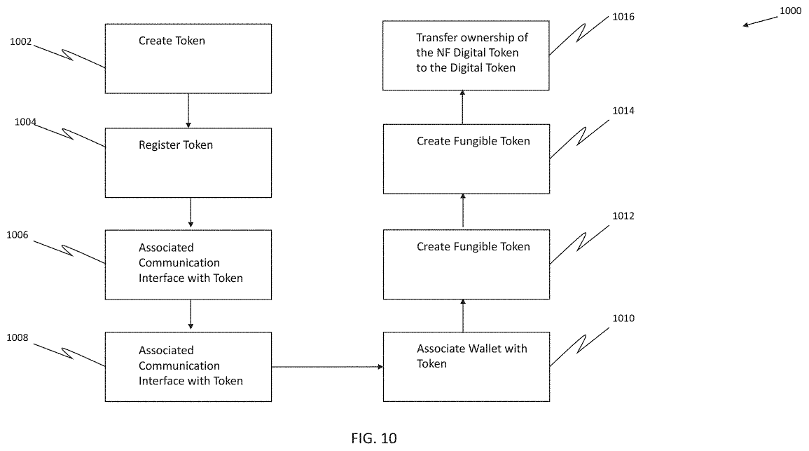

FIG. 10 Illustrates a method 1000 for configuring a data storage and retrieval system for managing data relating to tokenized assets. At 1002 a digital token is created in accordance with a class definition, the token including a unique token identifier. At 1004, the digital token is registered in association with an asset as a unique record in a memory device of an asset registry. At 1006, a communication interface is associated with the digital token in accordance with the class definition. The communication interface can be compliant with a communication specification implemented by the asset registry and which is configured to expose a set of predefined functions. The predefined functions can include asset ownership transfer functions, asset valuation publication functions, asset attribute determination functions and asset specific processing logic.

At 1010, a cryptographic wallet can be associated with the digital token. The wallet is configured to conduct token functions that are recorded in the asset registry. If the digital token is non-fungible, a fungible digital token can be created at 1012. At 1014, a cryptographic wallet can be associated with the fungible digital token. The wallet is configured to conduct token functions. At 1016 ownership of the non-fungible digital token can be transferred to the fungible digital token in order to wrap the non-fungible digital token with the fungible digital token and thereby enable fractional ownership of the asset represented by the non-fungible token including functions associated with shared ownership such as multi-party dividend distributions, corporate governance, and share trading.

In some implementations, method 1000 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1000 in response to instructions stored electronically on an electronic storage medium. The one or more processing devices may include one or more devices configured through hardware, firmware, and/or software to be specifically designed for execution of one or more of the operations of method 1000. For example, method 1000 can be implemented by the architecture of FIG. 1. Of course, the method may be implemented by a decentralized system, such as a distributed ledger, by a centralized system, or by a combination of the two types of systems.

The disclosed implementations improve data management and transmission in a manner that could revolutionize access to capital markets using Distributed Ledger Technologies (DLT) to create assets with comprehensive, built-in transparency, immutability, and transaction efficiency. The implementations provide a systematic and scalable framework to apply these benefits to fund management for any asset class providing issuers an easy path to market with innovative strategies. When used in connection with the compliance aware fungible tokens described in in US Published Patent Application No. US20190164151 A1, dividends, coupon payments, or other distributions can be automated through embedded smart contract logic permitting direct payments to token holder wallets.

Additional alternative structural and functional designs may be implemented for conducting asset management functions. Thus, while implementations and examples have been illustrated and described, it is to be understood that the invention is not limited to the precise construction and components disclosed herein. Various modifications, changes and variations may be made in the arrangement, operation and details of the method and apparatus disclosed herein without departing from the spirit and scope of the invention defined in the appended claims.

What is claimed:

1. A method for configuring a data storage and retrieval system for managing data relating to tokenized assets, the method comprising:
creating a digital token in accordance with a class definition, the token including a unique token identifier;
registering the digital token in association with an asset as a unique record in a memory device of an asset registry; and
associating a communication interface with the digital token in accordance with the class definition, wherein the communication interface is compliant with a communication specification implemented by the asset registry and which is configured to expose a set of predefined functions, wherein the predefined functions include asset ownership transfer functions, asset valuation publication functions, asset attribute determination functions and asset specific processing logic.

2. The method of claim 1, further comprising associating a cryptographic wallet with the digital token, whereby the wallet is configured to conduct token functions that are recorded in the asset registry.

3. The method of claim 2, wherein the asset ownership transfer functions include at least one of a Create Sell Order function, a Cancel Sell Order function an Accept Sell Order Function, a Create Purchase Order function, and Cancel Purchase Order Function, and Accept Purchase Order Function, and a Reject Purchase Order Function.

4. The method of claim 2, wherein the digital token is a non-fungible token and the asset is a non-fungible asset.

5. The method of claim 4, further comprising:
creating a fungible digital token;
associating a cryptographic wallet with the fungible digital token, whereby the wallet is configured to conduct token functions;
transferring ownership of the non-fungible digital token to the fungible digital token in order to wrap the non-fungible digital token with the fungible digital token and thereby enable fractional ownership of the asset represented by the non-fungible token including functions associated with shared ownership such as multi-party dividend distributions, corporate governance, and share trading.

6. The method of claim 5, further comprising associating a communication interface with the fungible digital token, wherein the communication interface is compliant with a communication specification and which is configured to expose a set of predefined functions, wherein the predefined functions include asset ownership transfer functions, asset valuation publication functions, asset attribute determination functions and asset specific processing logic.

7. The method of claim 6, wherein the non-fungible digital token represents a fund of assets and includes fund management functions.

8. The method of claim 5, wherein the fungible digital token is created in accordance with a token class definition, the fungible digital token including a unique token identifier.

9. The method of claim 1, further comprising:
creating a class registry consisting of asset classes each represented by a unique digital instrument or non-fungible token; and
wherein the non-fungible class token has a parent non-fungible class token, wherein the class of child tokens inherits the attributes and function of the parent class token; and
wherein the non-fungible asset tokens may be assigned a non-fungible asset class token to implement the classes attributes and functions based on the associated asset class token.

10. The method of claim 4, wherein the non-fungible token represents an asset that is a fund of assets and is assigned a fund asset class token in the asset registry.

11. The method of claim 9, wherein the asset associated with the non-fungible token is a fund and the assets respectively associated with the child tokens are non-fungible assets and/or fungible assets that are owned by the fund and the subset of the specified functions are operative to enumerate all child assets, add or remove child assets from the fund, and calculate a derived fund valuation based on the child assets in the fund at any specified time.

12. The method of claim 10, further comprising transferring at least one of the child token to the wallet associated with the fungible token in accordance with the asset ownership transfer functions, wherein the asset ownership transfer functions include at least one of a function for asset purchase, asset redemption, and asset ownership management.

13. The method of claim 10, wherein a smart contract monitors point-in-time capital inflow and outflows of the fund and creates an optimized balance of the assets owned by the fund by increasing or decreasing the price of one or more of the child tokens.

14. The method of claim 8, wherein all tokens of class can be upgraded at the same time by creating, updating, or removing attributes or functions associated with the class token.

15. A system for configuring a data storage and retrieval system for managing data relating to tokenized assets, the system comprising:
at least one computer processor; and
at least one memory device having computer readable instructions stored thereon which, when executed by the at least one computer processer, cause the at least one computer processor to carry out the method comprising:
creating a digital token in accordance with a class definition, the token including a unique token identifier;
registering the digital token in association with an asset as a unique record in a memory device of an asset registry; and
associating a communication interface with the digital token in accordance with the class definition, wherein the communication interface is compliant with a communication specification implemented by the asset registry and which is configured to expose a set of predefined functions, wherein the predefined functions include asset ownership transfer functions, asset valuation publication functions, asset attribute determination functions and asset specific processing logic.

16. The system of claim 15, the method further comprising associating a cryptographic wallet with the digital token, whereby the wallet is configured to conduct token functions that are recorded in the asset registry.

17. The system of claim 16, wherein the asset ownership transfer functions include at least one of a Create Sell Order function, a Cancel Sell Order function an Accept Sell Order Function, a Create Purchase Order function, and Cancel Purchase Order Function, and Accept Purchase Order Function, and a Reject Purchase Order Function.

18. The system of claim 16, wherein the digital token is a non-fungible token and the asset is a non-fungible asset.

19. The system of claim 18, the method further comprising:
creating a fungible digital token;
associating a cryptographic wallet with the fungible digital token, whereby the wallet is configured to conduct token functions;
transferring ownership of the non-fungible digital token to the fungible digital token in order to wrap the non-fungible digital token with the fungible digital token and thereby enable fractional ownership of the asset represented by the non-fungible token including functions associated with shared ownership such as multi-party dividend distributions, corporate governance, and share trading.

20. The system of claim 19, the method further comprising associating a communication interface with the fungible digital token, wherein the communication interface is compliant with a communication specification and which is configured to expose a set of predefined functions, wherein the predefined functions include asset ownership transfer functions, asset valuation publication functions, asset attribute determination functions and asset specific processing logic.

21. The system of claim 20, wherein the non-fungible digital token represents a fund of assets and includes fund management functions.

22. The system of claim 19, wherein the fungible digital token is created in accordance with a token class definition, the fungible digital token including a unique token identifier.

23. The system of claim 15, the method further comprising:
creating a class registry consisting of asset classes each represented by a unique digital instrument or non-fungible token; and
wherein the non-fungible class token has a parent non-fungible class token, wherein the class of child tokens inherits the attributes and function of the parent class token; and
wherein the non-fungible asset tokens may be assigned a non-fungible asset class token to implement the classes attributes and functions based on the associated asset class token.

24. The system of claim 20, wherein the non-fungible token represents an asset that is a fund of assets and is assigned a fund asset class token in the asset registry.

25. The system of claim 24, wherein the asset associated with the non-fungible token is a fund and the assets respectively associated with the child tokens are non-fungible assets and/or fungible assets that are owned by the fund and the subset of the specified functions are operative to enumerate all child assets, add or remove child assets from the fund, and calculate a derived fund valuation based on the child assets in the fund at any specified time.

26. The system of claim 24, further comprising transferring at least one of the child token to the wallet associated with the fungible token in accordance with the asset ownership transfer functions, wherein the asset ownership transfer functions include at least one of a function for asset purchase, asset redemption, and asset ownership management.

27. The method of claim 24, wherein a smart contract monitors point-in-time capital inflow and outflows of the fund and creates an optimized balance of the assets owned by the fund by increasing or decreasing the price of one or more of the child tokens.

28. The method of claim 22, wherein all tokens of class can be upgraded at the same time by creating, updating, or removing attributes or functions associated with the class token.
